(19) United States
(12) Patent Application Publication
(10) Pub. No.: US 2022/0182561 A1
(43) Pub. Date: Jun. 9, 2022

(54) WIDE FIELD OF VIEW IMAGING SYSTEM FOR VEHICLE ARTIFICIAL INTELLIGENCE SYSTEM

(71) Applicant: DIGITAL DIRECT IR, INC., Fresh Meadows, NY (US)

(72) Inventor: Peter N. Kaufman, Fresh Meadows, NY (US)

(21) Appl. No.: 17/493,836

(22) Filed: Oct. 4, 2021

Related U.S. Application Data
(60) Provisional application No. 63/087,230, filed on Oct. 4, 2020.

(51) Int. Cl. H04N 5/341; H04N 5/378

(52) U.S. Cl. CPC H04N 5/3415; H04N 5/378

(57) ABSTRACT

A system comprises a photodetector array comprising a plurality of pixels, and a plurality of image processors. The photodetector array is logically partitioned into a plurality of regions comprising a central region, a first peripheral region, and a second peripheral region. Each image processor is configured to process image data generated by a respective one of the regions of the photodetector array.

### CROSS-REFERENCE TO RELATED APPLICATION

This application claims the benefit of U.S. Provisional Application No. 63/087,230, filed on Oct. 4, 2020, the disclosure of which is fully incorporated herein by reference.

### BACKGROUND

This disclosure generally relates to techniques for implementing imaging systems to support artificial intelligence systems for automated vehicle control. The current and future automotive market requires multiple modes of external sensor modalities to facilitate automated driver-assistance systems (ADAS) as well as other automated systems for the development and implementation of various types of autonomous vehicles (e.g., cars, trucks, trains, taxis, busses, boats, etc.). As is known in the art, ADAS comprise groups of electronic systems that are configured to assist individuals in driving and parking their vehicle. For example, ADAS utilize automated technology, such as sensors (e.g., LIDAR (light detection and ranging) sensor, RADAR (radio detection and ranging) sensors, ultrasonic sensors, etc.) and cameras (e.g., visible light cameras, infrared (IR) cameras, etc.), to detect nearby obstacles or driver errors, and respond accordingly.

In addition, autonomous vehicles (e.g., self-driving vehicles) employ a wide range of sensor and imager technologies to automatically control operation of a motor vehicle and safely navigate the motor vehicle as is operates on roads. For ADAS and autonomous vehicle applications, the various sensor and imager technologies are used in conjunction with one another, as each one provides a layer of autonomy that helps make the entire system more reliable and robust. AI (artificial intelligence) applied to Autonomous Vehicles and ADAS (automated driver assistance systems) are looming on the near horizon of the automotive and transportation industries. Car manufacturers are slowly increasing the level of autonomous performance each year by adding more and advanced sensors and decision-making capability.

There is tremendous potential to almost eliminate transportation injuries, deaths and property damage from the failings of human operation, environmental conditions, driver expertise, infrastructure failures and limitations, and interaction between vehicles. Secondary benefits are much lower transportation costs per mile, fuel efficiency and improved carbon footprint to name a few.

These Automotive AI systems operate from multiple sensors on each vehicle. These sensors cumulatively present tremendous amounts if surroundings and situation data to the vehicles' on-board computer to be able to make real-time decisions on the vehicle's operation. The vehicles will also communicate with near-by vehicles as well as the Cloud for area awareness and control of traffic flow. All these things will be of tremendous benefit to our society and the successful growth of our economy.

As mentioned above, there are tremendous amounts of data to be processed by each vehicle, local control systems and large-scale operations via the Cloud connections to each vehicle as well as vehicle-to-vehicle communications. Anything that can be done to minimize the data flow from the sensors and vision systems is very important to the success, safety and effectiveness of this technology.

### SUMMARY

Exemplary embodiments of the disclosure include systems and methods for implementing imaging systems to support artificial intelligence systems for automated vehicle control. In one exemplary embodiment, a system comprises a photodetector array comprising a plurality of pixels, and a plurality of image processors. The photodetector array is logically partitioned into a plurality of regions comprising a central region, a first peripheral region, and a second peripheral region. Each image processor is configured to process image data generated by a respective one of the regions of the photodetector array.

Other embodiments will be described in the following detailed description of exemplary embodiments, which is to be read in conjunction with the accompanying figures.

### BRIEF DESCRIPTION OF THE DRAWINGS

FIG. 1 illustrates an exemplary field of view (FOV) which is optimal for ADAS (advanced driver assistance systems), and AI (artificial intelligence) systems to have sufficient forward-looking vision in central and peripheral regions, as compared to a limited FOV which is seen through a windshield.

FIG. 2 illustrates a FOV that is obtained by a conventional VGA car IR camera providing 640 Horizontal by 480 Vertical pixels, providing a 4:3 aspect ratio

FIG. 3 shows a wide FOV that is achieved using a wide field of view imaging system according to an exemplary embodiment of the disclosure.

FIG. 4 schematically illustrates a screen mesh which simulates a wide field of view imaging system according to an exemplary embodiment of the disclosure.

FIGS. 5, 6 and 7 schematically illustrates fast scanning techniques which can be implemented in peripheral regions of a wide FOV imager to detect object motion, according to exemplary embodiments of the disclosure.

FIGS. 8A and 8B illustrate a method for automated steering of a motor vehicle using an AI AV system supported by a wide FOV vision system, according to an exemplary embodiment of the disclosure.

FIG. 9 schematically illustrates an imaging system, according to an exemplary embodiment of the disclosure.

### DETAILED DESCRIPTION

Embodiments of the disclosure will now be described in further detail with regard to vision system imaging and data processing schemes along with companion vision imaging technology hardware to implement as meaningful amount of data reduction while still maintaining the critical levels of situation awareness, overall safety and still reap the economic benefits of applying AI to transportation.

It is to be understood that the various layers, structures, and regions shown in the accompanying drawings are schematic illustrations that are not drawn to scale. Moreover, it is to be understood that same or similar reference numbers are used throughout the drawings to denote the same or similar features, elements, or structures, and thus, a detailed explanation of the same or similar features, elements, or structures will not be repeated for each of the drawings. The term “exemplary” as used herein means “serving as an example, instance, or illustration”. Any embodiment or design described herein as “exemplary” is not to be construed as preferred or advantageous over other embodiments or designs.

Further, it is to be understood that the phrase “configured to” as used in conjunction with a circuit, structure, element, component, or the like, performing one or more functions or otherwise providing some functionality, is intended to encompass embodiments wherein the circuit, structure, element, component, or the like, is implemented in hardware, software, and/or combinations thereof, and in implementations that comprise hardware, wherein the hardware may comprise discrete circuit elements (e.g., transistors, inverters, etc.), programmable elements (e.g., ASICs, FPGAs, etc.), processing devices (e.g., CPUs, GPUs, etc.), one or more integrated circuits, and/or combinations thereof. Thus, by way of example only, when a circuit, structure, element, component, etc., is defined to be configured to provide a specific functionality, it is intended to cover, but not be limited to, embodiments where the circuit, structure, element, component, etc., is comprised of elements, processing devices, and/or integrated circuits that enable it to perform the specific functionality when in an operational state (e.g., connected or otherwise deployed in a system, powered on, receiving an input, and/or producing an output), as well as cover embodiments when the circuit, structure, element, component, etc., is in a non-operational state (e.g., not connected nor otherwise deployed in a system, not powered on, not receiving an input, and/or not producing an output) or in a partial operational state.

It is to be further noted that the terms “imaging device” or “imager” or “imaging system” as interchangeably used herein denote systems and devices which collectively include optical devices, at least one photodetector array, and an associated readout integrated circuit (ROIC). The optical devices (e.g., mirrors, focusing lens, collimating lens, etc.) are configured to direct incident light to the photodetector array, wherein the photodetector array comprises a plurality of photodetectors (pixels) which are configured to convert the incident photonic energy to electrical signals (e.g., current or voltage). The ROIC is configured to accumulate the electric signals from each pixel and transfer the resultant signal (e.g., pixel data) to output taps for readout to a video processor. In some embodiments, the ROIC comprises a digital ROIC which generates and outputs digital pixel data to a video processor. The types of photodetectors or photosensors used will vary depending on whether the imager device is configured to detect, e.g., visible light, infrared (IR) (e.g., near, mid and/or far IR), or other wavelength of photonic energy within the electromagnetic spectrum. For example, in some embodiments, for visible light imagers, the photodetector array may comprise an RGB focal plane array (FPA) imager which comprises an array of red (R), green (G), and blue (B) pixels (e.g., Bayer Filter pixels), wherein a Bayer filter mosaic provides a color filter array for arranging RGB color filters on a photosensor array.

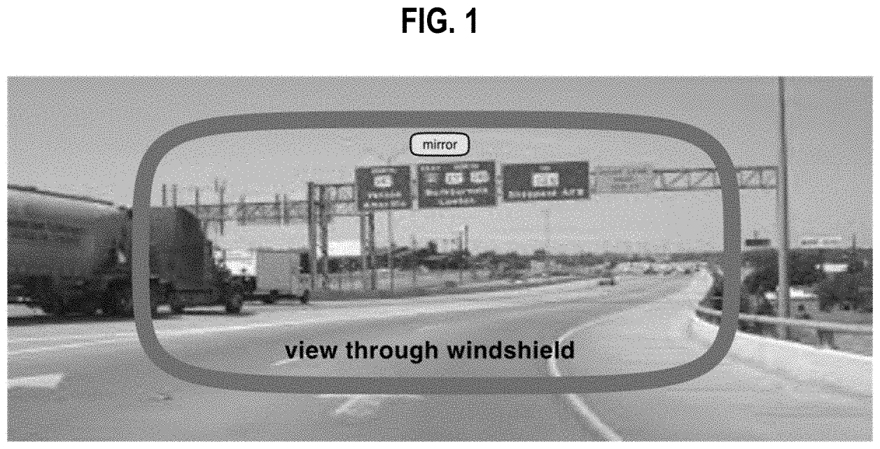

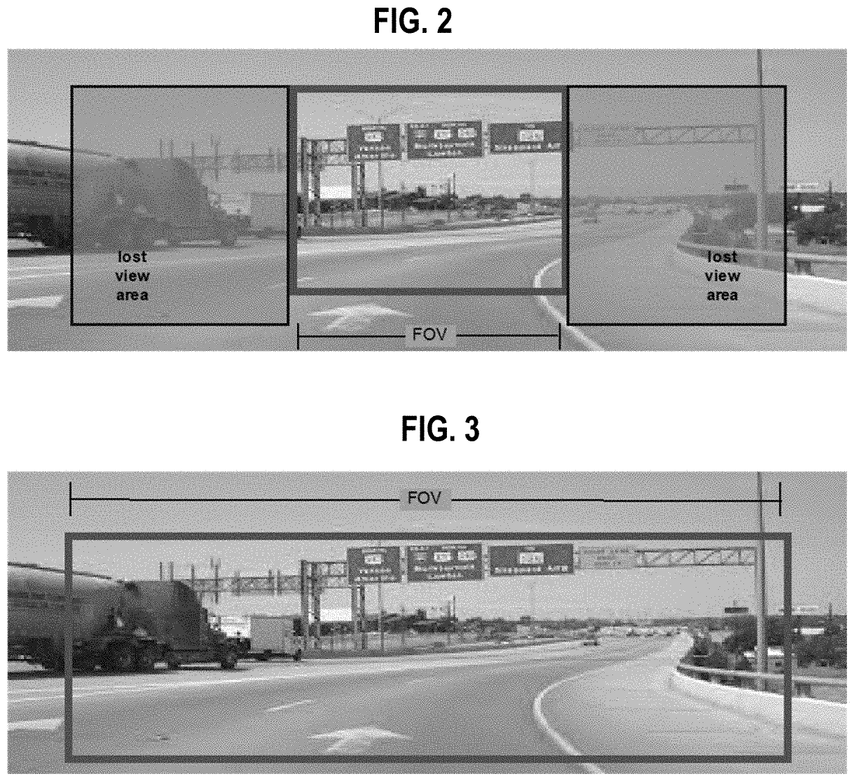

FIG. 1 illustrates an exemplary field of view (FOV) which is optimal for ADAS (advanced driver assistance systems), and AI (artificial intelligence) systems to have sufficient forward-looking vision in a central and peripheral region, as compared to a limited FOV which is seen through a windshield. FIG. 2 illustrates a FOV that is obtained by a conventional VGA car IR camera providing 640 Horizontal by 480 Vertical pixels, providing a 4:3 aspect ratio which is very poor. In particular, FIG. 2 shows a very narrow central field of view which is insufficient for effective and safe situation awareness. There can be dangerous conditions outside of the imager's field of view, illustrated by the lost view regions in FIG. 2.

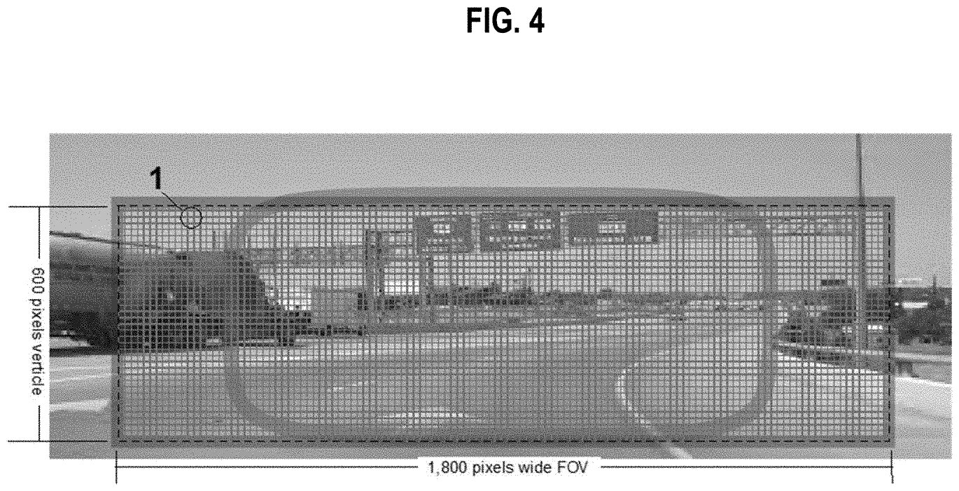

FIG. 3 shows a wide FOV that is achieved using a proprietary EWFOV (extremely wide field of view) Dual-Spectrum thermal infrared imager (referred to herein as “D2IR imager”) according to an exemplary embodiment of the disclosure, which provides maximum incident scene information for the ADAS μPc to make the best decisions with regard to analysis, maneuvering, safter and successful travel. FIG. 3 is in contrast to lower resolution systems which cannot see critical information within the periphery, which may pose a significant danger. With conventional systems, in order to image these peripheral areas, lower resolution systems have to use wider FOV lenses and spread the picture out over the smaller FPA, which drastically cuts down on the quality and clarity of the data the imager sends to the systems μPc for analysis, sacrificing situation awareness and safety. This is because the resulting images are blurry which takes longer and makes it harder for the AI system to identify objects in the scene and make a decision.

Exemplary embodiments of the disclosure provide Extreme Wide Field of View IR cameras with a resolution of, e.g., 800 Horizontal by 600 Vertical pixels, providing an optimal 3:1 aspect ratio. This resolution provides maximum data for an ADAS AI system to provide fast and efficient decisions, especially at highway speeds, where it is necessary to be able to acquire scene data from the maximum encroaching area. The exemplary D2IR Imager 1-megapixel camera has three-times more pixels to process and deliver situation awareness, as compared to conventional imagers.

In order to facilitate Artificial Intelligence (AI) being applied to Automotive Vehicle Autonomous Operation and ADAS (advanced driver assistance systems), there is real world surroundings information and object data that must be made available to the system. Many forms of data are provided by an array of different types of sensors, such as Thermal IR Imaging. The quantity of data coming from these imagers and sensors is enormous. All the enhancements and capabilities in this disclosure are applicable to all the vision systems used in all forms of transportation and shipping for vehicle safety systems as well as ADAS and Autonomous Vehicle development and implementation for visible, near, mid and far infrared imaging.

The large amount of sensor data presents a problem for the AI systems accessing this information, as it needs to be processed in almost real-time to be able to permit operation of the ADAS and Autonomous Driving systems. Any enhancement that can reduce the amount of data going to the main AI processors while still maintaining the needed level of information and situation awareness is a welcome and important addition.

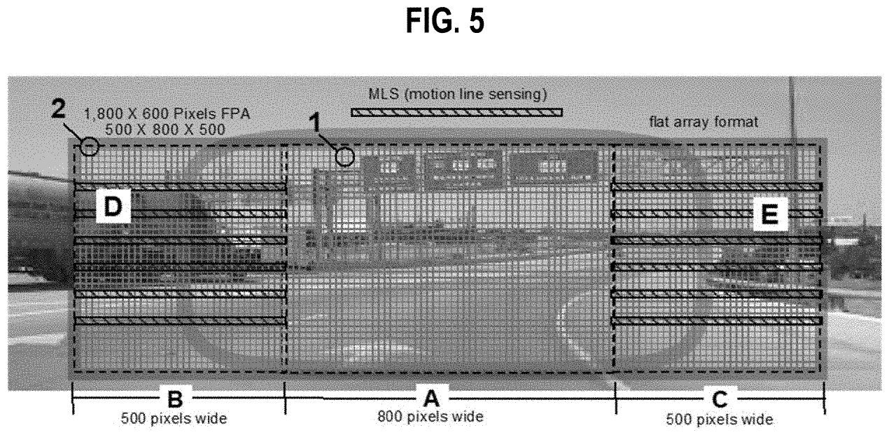

The exemplary D2IR imager designs as disclose herein have very high resolution (high pixel count, e.g., FIG. 4), which means there is a tremendous amount of data to process. In order to reduce the decision time of the AI system, we reduce the amount of data to input without sacrificing situation awareness, safety and reliability. To do so, exemplary embodiments adapt an image object recognition methodology that the human eye to brain vision system implements.

There are conventional thermal imaging systems currently used in the automotive industry, which are used in other application such as security and surveillance. These systems are typically ¼ VGA (320 by 240 resolution with 76,800 pixels), while some are full VGA (640 by 480 resolution with 307,200 pixels). In general, the higher the resolution (more pixels) the more information can be provided to the AI system resulting in better situation awareness. More data means better decisions and safer operation. The lower resolution is being offered by the imaging industry to the car companies because the price points are very sensitive and the ¼ VGA cameras are the lowest cost but with a barely usable resolution.

Exemplary embodiments of the disclosure provide imager resolutions of at least 1,800 by 450 (810,000 pixels with 4:1 aspect ratio) and 1,800 by 600 (1,080,000 pixels with 3:1 aspect ratio) are much better choices. We can provide this using our proprietary IR detector technology and still maintain the price points the industry requires. High resolution with wide field of view is most important. The vertical resolution is not as critical as the horizontal. The system needs only to see what is in front of the vehicle to the horizon and to the port and starboard sides. Up in the sky is not an issue.

A primary factor is aspect ratio. Having a wide field of view allows the AI system to gather data from the center of the image field as well as the left and right periphery. Lower resolutions can still provide good aspect ratios but will have less image data to identify what objects are, their location, movement, speed and if they are coming into our sphere of influence. It is preferable to have aspect ratios 2.4:1 or better. Some other potential resolutions that could be implemented are: (i) 1,200×400=480,000 pixels (3:1); (ii) 1,600×450=720,000 pixels (3.5:1); (iii) 1,200×450=540,000 pixels (2.7:1); (iv) 1,600×500=800,000 pixels (3.2:1); (v) 1,200×500=600,000 pixels (2.4:1), (vi) 1,600×600=960,000 pixels (2.6:1), and (vii) 1,600×400=640,000 pixels (4:1). An ideal resolution would be: 1,800×600=1,080,000 (one megapixel) (3:1 aspect ratio) (see FIG. 4).

Imagers with higher resolutions and lower aspect ratios can make up for the aspect ratio in the software by concentrating on the central core and using the peripheral detectors to alert the system and ask for a high-resolution analysis of that incident scene or object. Then the software can examine the area in question and make a decision.

High resolution is paramount to the needs of the AI and safety systems. But there is a technical problem with high resolution. Cameras give huge amounts of data. To process all this data takes a very powerful computer. When you put a few different types of cameras and an array of sensors on a vehicle, that data processing of the AI system becomes a daunting and challenging task. A method to reduce the data flow from our camera while still maintaining situation awareness would be an important asset. We can do this through inventive imager ROIC access techniques, software techniques and multi-processor simultaneous data analysis, processing and storage of object data for access by the main AI system as a look back capability. This way the main processor doesn't have to monitor the peripheral areas unless a situation trigger has occurred, say for instance an object moving in the sphere of influence of the vehicle. Then all it has to do is inquire from the peripheral processor the specific data from the object or situation in question because the object identification has already been made. This will allow much faster and accurate decisions.

Our human visual system contains the eye and the visual cortex of the brain. This combination collects the data of the field of view to allow the brain to make decisions on how to react. There is a three-part visual aspect to the eye and the visual cortex to increase the speed of processing and supply the best situation awareness. Visual input from the macula occupies a substantial portion of the brain's visual capacity. The Fovea contains the largest concentration of light sensitive cells and the clearest vision. The Macula has slightly less and the Retina the least.

If we copy the human vision design, we have a central vision core that has high resolution for us to be able to have hand-eye coordination, coordinated locomotion and recognition of our surroundings. The peripheral vision to the left, right, up and down have lower resolution as it is only used to determine if an object is coming into our field of interest. Once we notice the object, we shift our central vision to that object so we can identify it and determine the proper action to take.

This is similar conceptually to what is needed for an automotive imaging system. The central core of the image tells us what is in front of us and how to proceed. The peripheral vision alerts us to potential obstacles or dangers that are approaching the space we are moving into or where we are. We then shift to the high-resolution central core vision to determine if it is safe to proceed, or if another action is required.

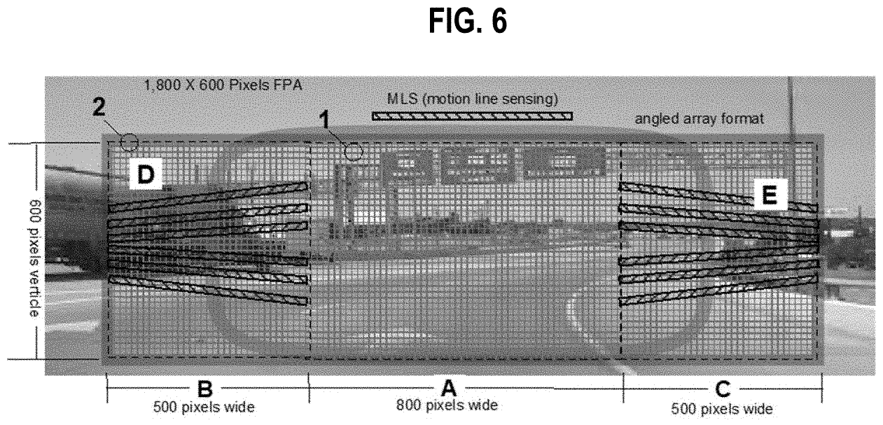

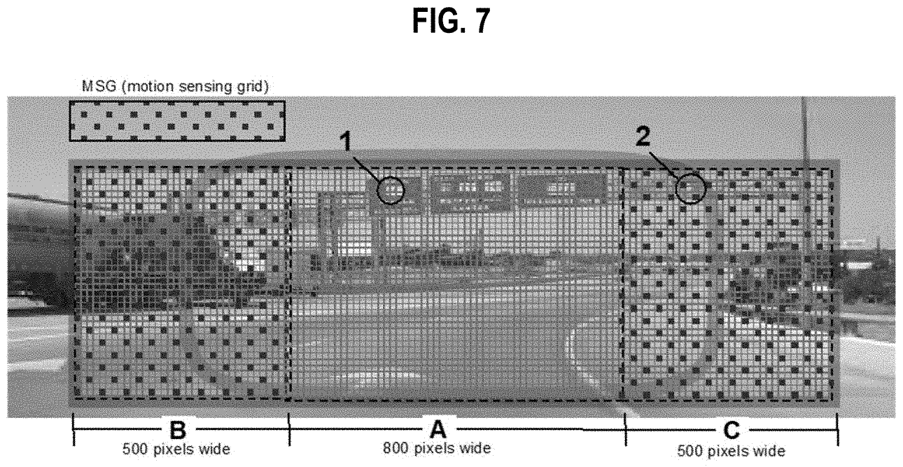

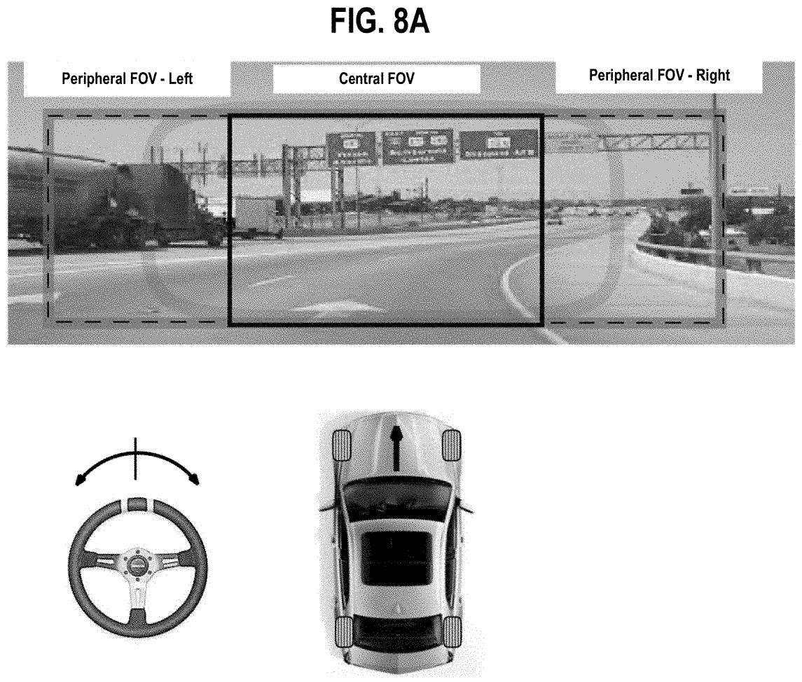

FIG. 4 illustrates a wide FOV image for a full array mode of operation. The main reads the data from the complete FPA to acquire the maximum scene data and situation awareness. This uses the full complement of active pixels (1) and requires the most processor time and memory. Other image data acquisitions techniques can be utilized to limit the amount of image data that needs to be sent to the AI processor and analyzed at given time. Such techniques are illustrated in FIGS. 5, 6, and 7. FIGS. 5 and 6 illustrates fast scanning line techniques, while FIG. 7 illustrates grid pixel techniques. The fast-scanning line and grid pixel formation can be activated and deactivated by the system software as needed from the incident scene content analysis results. They can also be switched on the fly in any sequence needed to search for patterns and objects (to look for items) that will trigger the AI's criteria for closer scrutiny.

In the exemplary illustrates of FIGS. 4, 5, 6, and 7, a screen like mesh (1) simulates the pixels of the full array, which in FIG. 4 is shown to be 1,800 by 600 resolution (1.08 megapixels). In FIGS. 5, 6 and 7, the portions (1) and (2) together make up the full detector array and are also 1.08 megapixels. The central portion of the array (A) in FIGS. 5, 6, and 7 is comprised of the detectors that are monitored continuously as the most important source of incident scene information. The peripheral regions of pixels (B) and (C) FIGS. 5, 6 and 7, are utilized for secondary peripheral information. The peripheral image data in regions (B) and (C) are read at regular rates by secondary video processors and the analysis data is stored for later access if needed.

The MLS (motion line sensing) processes shown in FIGS. 5 and 6 comprise lines of detectors (D) and (E) in the peripheral regions (B) and (C) which are continuously monitored to detect object motion in the peripheral regions. The MSG (motion sensing grid) shown in FIG. 7 comprises a grid of detectors in the peripheral regions (B) and (C) which are continuously monitored to detect object motion in the peripheral regions. The specific detectors (MLS and MSG) are singled out from the array by the secondary μPc and accessed via the ROIC to provide real time data to the secondary μPc, which monitors and looks for new objects moving into, out of and stationary in the peripheral FOV areas. If these objects meet the alarm criteria, the main processor is alerted to look at the stored scene analysis data to ascertain the value of the object in the list of criteria the AI system will analyze. If not asked for, the system has the option of deleting the data after a predetermined length of time or if memory space is needed for newer incident scene data.

The main central array section (A) has a higher frame rate (in this example 30 FPS) imaging and is presented to the main video μPc for analysis. The peripheral array sections (B) and (C) are scanned at an appropriate frame rate, but the image data is stored by a separate peripheral μPc with its own memory or a partition of the main memory map. The MLS and MSG overlays are scanned at a faster rate than the central array, for example 60 FPS. The data from the MLS and MSG arrays is stored by the peripheral μPc long enough to determine if alarm criteria have been met. If not, the data is discarded. If the criteria are met, then the main μPc looks at the data stored by the peripheral μPc to determine the nature and importance of the content before it has moved into the main central array and poses a danger to the vehicle and if action is required. The purpose of the peripheral system is to save processing time for the main μPc and reduce the work it has to do. The main μPc can implement full array (A, B & C) monitoring of the AI system makes that decision.

The peripheral zone horizontal line grid fast scanning format of FIG. 5 provides a strategy for fast scanning on the peripheral areas with horizontal line grid formats. The three visual segments operate in combination or individually. The peripheral zone angled line grid fast scanning formation of FIG. 6 provides a strategy for fast scanning on the peripheral areas with angled line grid formats. The three-visual segments (A, B & C) operate in combination or individually. FIG. 7 shows motion sensing array grid for fast scanning the peripheral areas with a subset of active detectors.

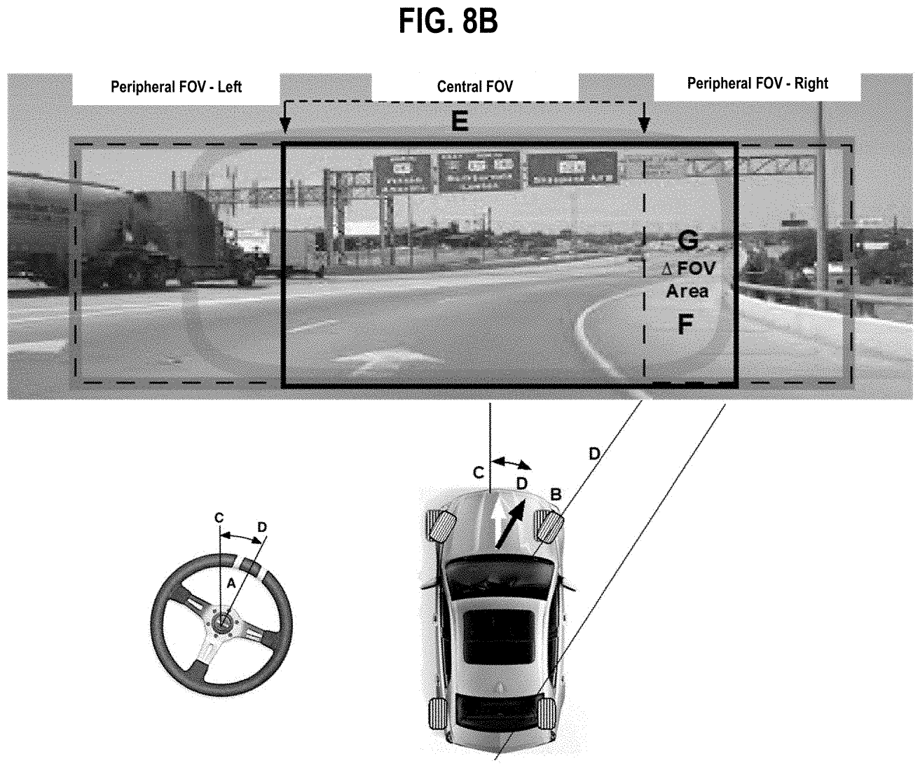

FIGS. 8A and 8B illustrate a method for automated steering of a motor vehicle using an AI AV system supported by a wide FOV vision system, according to an exemplary embodiment of the disclosure. FIG. 8A shows a vehicle moving in straight direction of the center line of the central FOV. When the car turns, the size if the central FOV which is continuously active can be dynamically modified to enable increased vision system resolution as the care is turning. This is shown in FIG. 8B.

There is a delay between the time the steering wheel (A) and the front wheels (B) turn, until the forward motion of the vehicle's vectors (C) changes to direction (D). A sensor will provide wheel position and angle data (B) to the camera to be able to modify the Central FOV (E) to add the new ΔFOV Area (F) to follow the projected path of the vehicle. The imaging system looks to the new direction and adds area (F) (ΔFOV) to the main Central FOV (E) to anticipate arriving at the new location (G). The width of the ΔFOV area (F) is determined by the difference of the steering wheel position going straight (C) and the new steering wheel angle position (D). Once the steering wheel and vehicle have resumed a zero vector, the FOV returns to normal (E). The concept is that, a ΔFOV is interactive with the direction of the steering system and the speed of the vehicle. The ROIC in the camera can have the FOV reconfigured on the fly to accommodate a new vehicle path before it actually gets there. When the turn signal is activated and the steering wheel is turned the camera will survey the new travel area and report to the central AI system. The system can either shift the central FOV or use the left and right secondary FOV sections. In this regard, FIG. 8B illustrates a process in which the video field of interest follows the positional direction of the steering wheel.

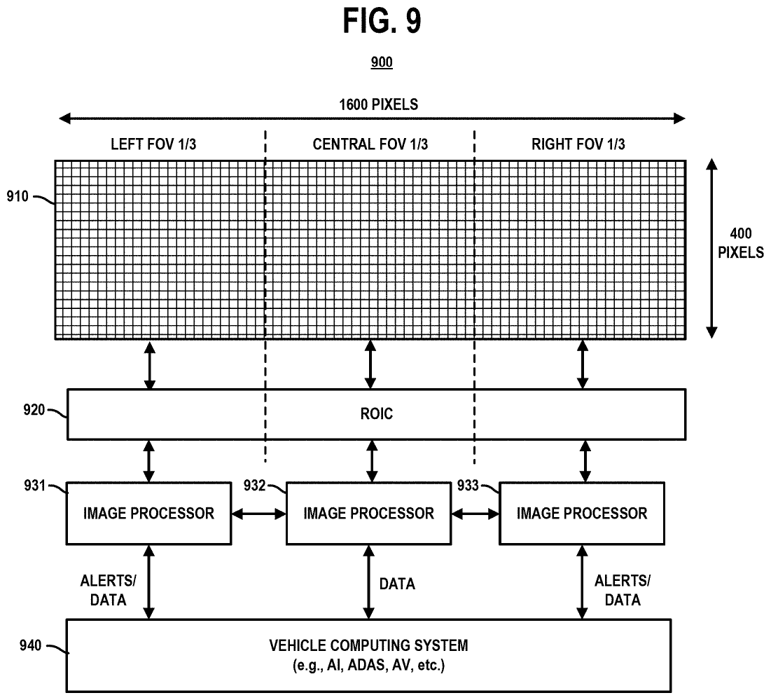

FIG. 9 schematically illustrates an imaging system 900 according to an exemplary embodiment of the disclosure. The imaging system 900 comprises a photodetector array 910, a readout integrated circuit 920, a plurality of image processors 931, 932, and 933 (or video processors), and a vehicle computing system 940. The vehicle computing system 940 comprises a computer system having processors that execute programs to implement one or more artificial intelligence (AI) systems, ADAS, and/or autonomous vehicle control systems using, e.g., image data captured by the imaging system 900. The photodetector array 910 comprises an array of thermal IR detectors or visible light detectors having a high resolution, e.g., 1600 pixel by 400 pixels. The photodetector array and ROIC 920 are logically partitioned into three regions, including a central FOV region and two peripheral FOV region, denoted left FOV and right FOV. In the exemplary embodiment, the portioning is essentially equal where each region includes ⅓ of the total number of pixels of the detector array 910. The image processor 931, 932, and 933 control the respective regions. In some embodiments, the image processor 932, which control the pixels in the central FOV region operates as a master processor, which controls the logical partitioning of the array 910 and associate ROIC 920, such that the image processors 931 and 933 operate as slaves with regard to partitioning control.

In operation, there is a continuous flow of image data (associated with the central FOV) from the image processor 932 to the vehicle computing system 940. This image data is continuously processed by the AI system to make decisions. On the other hand, the peripheral image processors 931 and 933 will process the image data in the peripheral regions of the array 910 (e.g., left and right FOV) to detect conditions (e.g., object motion) which would warrant further consideration by the AI system to make automated control decisions. In such instance, the image processors 931 and 933 would send an alert to the AI computing system 940, and then send image data from the peripheral regions to the AI computing system 940 in response to the system 940 confirming to send the additional data. Thus, the constant data flow to the AI g is only 33%, leaving 66% out of the g responsibility most of the time. When the left or right areas detect something that needs attention, they alert the central g and sends the data for analysis by the AI.

The peripheral image processors 931 and 933 can utilized one or more of the scanning techniques of FIG. 5, 6, or 7, to processes a limited amount of image data to detect for alert conditions. In some embodiments, the image/video processors have access to a sufficient amount of storage to store at least 10-20 seconds of video data for analysis.

In summary, exemplary embodiments of the disclosure provide data acquisition techniques that facilitate a central main field of view as well as peripheral fields for the left and right of the central FOV. In addition, a software program, ROIC or hardware methodology are implemented to allow for horizontal stripes or a grid of detection areas in the peripheral areas. This will permit the fast scanning of the areas for data that will indicate that a higher resolution examination of the area is needed to determine if any action is required to maintain safety and situation awareness. A method is provided to have separate stripes or grid of pixels for data acquisition in the peripheral areas that can be monitored by a separate μP. If conditions are present that require more attention, those areas have full resolution capability that can be accessed at that or any time from the Peripheral μP memory. It can also backtrack to look at previous peripheral frames that have been stored and ready if needed for confirmation of conditions or situations. It would be advantageous to have the peripheral areas monitored in full resolution by a separate that can keep track of the objects in those areas. If the stripe or grid data triggers an alert condition the main μP can quickly access the object data stored analyzed previously by the peripheral μPc, and make a much faster decision than if it had to monitor all three sections in real time. It will greatly reduce the amount of data the main μPc and AI system has to process. In some embodiments, there are three image processors, one each for the central FOV section, and the two peripheral FOV's. The peripheral μPc's can interrupt the main μPc at any time to handle the task of the situation awareness in those areas. The motion sensing arrays (MSA, consist of MLS's and MSG's) of various pixel arrangements can gather scene data at a faster rate that the full array because the MSA's have much fewer pixels to process. The pixels are part of the full array but are accessed by the ROIC in a separate scan sequence from the full array scanning. This MSA function mimics the function of the human eye in that the central image area has the highest resolution to be able to identify scene elements with the highest accuracy. The peripheral areas have much lower pixel concentration as they only have to alert the brain of the possibility of an intrusive object or scene element. Video Field of interest follows the positional direction of the steering wheel.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising:
a photodetector array comprising a plurality of pixels; and
a plurality of image processors;
wherein the photodetector array is logically partitioned into a plurality of regions comprising a central region, a first peripheral region, and a second peripheral region;
where each image processor is configured to process image data generated by a respective one of the regions of the photodetector array.
